(19) United States
(12) Patent Application Publication
(10) Pub. No.: US 2013/0199272 A1
(43) Pub. Date: Aug. 8, 2013

(54) IN-PIPE MOBILE CROSS-CORRELATION-BASED SYSTEM FOR LEAK DETECTION

(71) Applicants: Atia Khalifa, Dhahran (SA); Rached Ben-Mansour, Dhahran (SA); Yehia Khulief, Dhahran (SA); Samir Mekid, Dhahran (SA); Kamal Youcef-Toumi, Cambridge, MA (US)

(72) Inventors: Atia Khalifa, Dhahran (SA); Rached Ben-Mansour, Dhahran (SA); Yehia Khulief, Dhahran (SA); Samir Mekid, Dhahran (SA); Kamal Youcef-Toumi, Cambridge, MA (US)

(73) Assignees: King Fahd University of Petroleum and Minerals, Dhahran (SA); Massachusetts Institute of Technology, Cambridge, MA (US)

(21) Appl. No.: 13/364,366

(22) Filed: Feb. 2, 2012

(51) Int. Cl. G01M 3/02

(52) U.S. Cl. 73/40.5 A

(57) ABSTRACT

Leak detection system. The system locates leaks in a pipeline that includes RFID tags deployed at known locations along the pipeline. A pair of bodies tethered to one another a fixed distance apart travels along the pipeline. Each of the bodies is supported for movement substantially along the centerline of the pipeline and each body includes a sensor responsive to sound or pressure variations generated by a leak. Signals are correlated to identify the existence of a leak. Each body also includes an RFID reader for reading the RFID tags in the pipeline. At least one of the bodies includes a power supply and/or electronics that are adapted to correlate signals from sensor on each body to determine the location of a leak within the pipeline.

### BACKGROUND OF THE INVENTION

This invention relates to leak detection and more particularly to an in-pipe system using sensors mounted on mobile bodies to detect and localize leaks by cross-correlation of sensor signals.

Leak correlators are widely used for leak detection in water distribution networks where two sensors, usually accelerometers or hydrophones, are connected to a pipeline at two fixed locations (e.g., two fire hydrants) such that they enclose an unknown leak. The two sensors capture the wave emitted by the leak and the time lag between the captured signals is used to detect and locate the leak. The sound propagation velocity in a pipe, which is a function of pipe material, diameter, thickness, etc., should be available as an input to the correlator.

The cross-correlation method works well with metal pipes; however, the effectiveness of the method is questionable when used with plastic pipes because of the high signal attenuation—particularly for high frequency components—due to the elasticity of the pipe material. Plastic pipes act as filters that attenuate the high frequency components of the leak noise with distance [2,3]. The attenuations of the signal depend on how far the leak location is from the sensors used for correlation. This means that the distance between the two sensors and the sensor ability (type and quality) to capture low frequency noise are of great importance. It has been reported that the low frequency content of the leak noise makes it very difficult to distinguish as a leak. Moreover, the propagation of low frequency sound/vibration will be limited by the impedance of the pipeline fittings and joints.

Leak characterization in pipelines using internal measurements of the acoustic or pressure signal generated by the leak is a growing and challenging topic. The motivation for venturing into the use of internal measurements stems from substantial capabilities: the ability to survey a long distance pipeline in a network, the ability to survey portions of the pipeline network that may be logistically difficult to access by other techniques and the ability to place a sensor very close to a leak location that supports better signals and detection. Thus, leak detection and localization become more independent of the pipe material, pipe diameter, pipe depth, soil type, background noise, and other environmental effects.

Experiments [4] have shown that hydrophones in direct contact with the water core can capture reliable leak signals to locate the leak using a signals correlation technique. Recent experimental tests on non-metallic pipes demonstrated that transient pressure measurements can be used equivalently as with acoustic measurements inside the pipe [5]. However, the distance between the two sensors is very critical to the correlation technique.

It is therefore an object of the present invention to provide a mobile system with one or more sensors moving inside a pipe network and continuously measuring acoustic or pressure waves to detect and localize leaks in the pipeline.

### SUMMARY OF THE INVENTION

The mobile system disclosed herein for moving inside a pipeline uses multiple signals from the sensors to detect leaks whether they are coming from one sensor and shifted in space and time, or coming from multiple sensors at different locations. Data available from multiple signals helps in performing a more accurate analysis for leak detection. A correlation algorithm is needed to process these multiple signals in order to identify the existence of a leak. The algorithm used for leak detection is based on the number of sensors, type of signals (whether they are shifted in space only or in time and space), and the design of the mobile system. For locating the mobile system of the invention, reference locations inside the pipe are used. These reference locations can also be used to calculate the speed of the system inside the pipe. RFID tags mounted inside the pipe are used as reference locations in a preferred embodiment.

The leak detection system according to the present invention for locating leaks in a pipeline that includes RFID tags deployed at known locations along the pipeline includes a pair of bodies tethered to one another a fixed distance apart, each body supported for movement substantially along the centerline of the pipeline. Each body includes a sensor responsive to sound or pressure variations generated by a leak and an RFID reader for reading the RFID tags in the pipeline. At least one of the bodies includes a power supply and/or electronics, the electronics adapted to correlate signals from the sensor on each body to determine the location of a leak within the pipeline. The electronics further include means for recording the signals for post-processing and may be a wireless communication device. It is preferred that each body be supported by wheels engaging the inside of the pipeline.

In a preferred embodiment, the sensors are hydrophones or dynamic pressure transducers.

The electronics may also include a processor for digitizing, filtering and correlating signals from the sensors on each body. The bodies may travel with flow in the pipeline or at least one of the bodies includes propulsion means for moving the bodies along the pipeline.

If the system of the invention is carrying only one sensor, then the signal may be divided into time slices and a correlation algorithm is able to detect the leak based on the relation between the data and the sequence of the slices. When a two sensors arrangement is used, it is better to separate them within a selected distance and the algorithm uses the corresponding signals from the two sensors and the distance separating them to detect the leak. Another embodiment is a leak detection “snake” with distributed sensors over its body and the algorithm in this case will se the data sequence from all sensors to detect a leak.

### BRIEF DESCRIPTION OF THE DRAWING

FIG. 1 is a schematic illustration of a leak detection system according to one embodiment of the invention.

FIG. 2 is a schematic illustration showing the mobile bodies in FIG. 1 mounted inside a pipeline that includes RFID tags.

### DESCRIPTION OF THE PREFERRED EMBODIMENT

The current invention is an integrated in-pipe mobile leak detection system that uses real time, onboard cross-correlation to detect and locate leaks in water (and other fluids) pipeline networks. The system disclosed herein takes advantage of being inside water (water is a good signal conductor) and being very close to a leak to avoid signal attenuation and contamination.

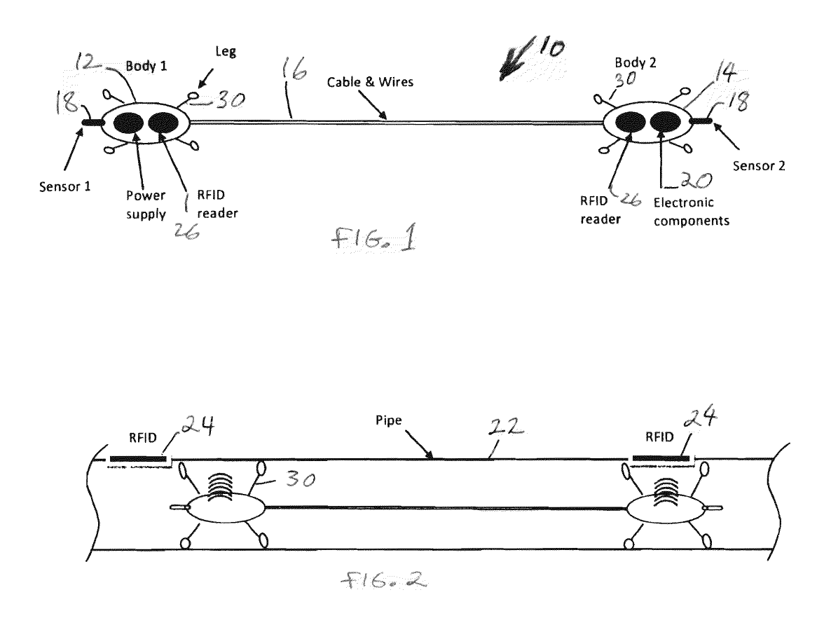

With reference now to FIG. 1 a system 10 includes two mobile bodies 12 and 14, similar to submarines, connected by an inextensible cable 16. The cable 16 has a fixed length but can go around pipeline bends and also includes electrical wires so that the first and second bodies 12 and 14 can communicate with one another and share power if desired. Each body 12 and 14 includes at least one miniaturized sensor 18. The sensors 18 are high response hydrophones or dynamic pressure transducers. One or both bodies carry an electronics board 20 that includes a processor for digitizing, filtering and correlating received signals from the two sensors 18.

Correlation results between the two signals recorded from the two sensors 18 are used for leak detection as those of skill in the art will understand.

The bodies 12 and 14 include RFID readers 26 that read and store information from the RFID tags 24 while moving inside the pipe 22 for localization. Instantaneous signal correlations and system location inside the pipe 22 are stored in a memory section of the electronic components 20 so that the information can be retrieved later for post-processing. The system disclosed herein is useable for all types of pipe materials. Moreover, it is able to find all leaks in the scanned pipeline portion in one deployment. The disclosed system is further able to filter out the normal flow turbulence noise. Because the two bodies 12 and 14 are tethered together by a cable which has a fixed length but can bend with pipeline bends, the system can negotiate pipe fittings, bends, and open valves. The bodies 12 and 14 may float inside the pipe with the normal pipe flow or propulsion can be provided.

In operation, the system disclosed herein moves inside the pipe 22 and takes continuous measurements using the two sensors 18 simultaneously. With on-board real time processing, leaks are detected based on the correlation of the two signals. Once a leak exists between the two sensors 18, the correlation function between the two signals will show a distinguished peak that identifies the leak existence. The system stores the data all the way along the scanned pipeline. Note that each of the bodies 12 and 14 includes legs 30 supporting wheels for engagement with the pipe 22. The legs 30 may be connected to the bodies 12 and 14 by torsional springs to negotiate changes in internal pipe diameter due to fittings or long-term fouling. The leg and wheel arrangement provides stability of motion, keeps the sensors at controlled positions, and secures smooth sliding at the contact points.

As shown in FIG. 2, each pipe segment in a pipeline network is internally fitted with RFID tags 24 so that the exact location of each segment in the network is previously known. Tagging the pipe segments during manufacturing is easy and relatively inexpensive so that the distance between tags can be kept to a minimum. An appropriate separation is two or three meters. This separation provides for accurate localization of the mobile system and any detected leaks. The system disclosed herein moves inside the pipe and reads the tag once passing it and stores its number. Later, during data retrieval, suspected leaks can be identified at specific pipe segments.

In an embodiment of the invention, the two sensors 18 are moving inside the pipe 22 at the same speed with a fixed distance separating them and the real-time correlation calculations may be carried out onboard.

Because the system of the invention is making measurements in a diffuse field, hydrophones that are used should be random-incidence ones. Alternatively, each body 12 and 14 may carry two sensors with different orientations with respect to the pipe 22 centerline to improve system sensitivity (by improving sensor directionality) and to perform more correlations for leak detection. It is believed; however, that directionality may not be a serious issue in the present embodiment as the leak is just one-half pipe diameter away from the sensor.

By using the two bodies 12 and 14, the combination works as an equivalent “wind Screen” to reduce turbulence by the fluid flow which could be interpreted as sound. Of course, the bodies carry a power supply sufficient for operating the sensors and the other electronic components. The length of the cable 16 is selected to match different application requirements.

As the system of the two bodies moves inside the pipe 22 the electronics module 20 records leak noise (or a pressure disturbance). The signal recording can be continuous or be an on/off timed system based on the correlation calculations.

In a case when there is little or no flow in the pipe 22, the system can be propelled with a propeller-like device as with a submarine. Noise emitted by such a propeller can be filtered out later during post-processing since the rotational speed of the propeller is known.

Because all the pipes used in the pipeline network are tagged and have ID numbers, post-processing will reveal accurately the location of the mobile system inside the pipe 22. The local speed of the system inside the pipe (and the water speed as well) can be calculated upon system retrieval using the time difference of reading two consecutive RFID tags by the two bodies 12 and 14 and the cable 16 length. Knowing the speed of the system and the change in the two signals relative to each other while moving inside the pipe is thus used for leak localization.

The numbers in square brackets refer to the references listed herein and the contents of all of these references are included herein by reference.

It is recognized that modifications and variations of the present invention will be apparent to those of ordinary skill in the art and it is intended that all such modifications and variations be included within the scope of the appended claims.

### REFERENCES

1. Hunaidi, O., “Detecting Leaks in Water-Distribution Pipes.” Photos courtesy of Palmer Environmental Ltd.
2. Bracken, M.; Hunaidi, O., 2005, “Practical aspects of acoustrical leak location on plastic and large diameter pipe”, Leakage 2005 Conference Proceedings, Halifax, N. S., pp. 448-452.

3. Hunaidi, O., and Chu, W. T., 1999, “Acoustical Characteristics of Leak Signals in Plastic Distribution Pipes,” Applied Acoustics, Vol. 58, pp. 235-254.

4. Hunaidi, O., Chu, W., Wang, A., and Guan, W., 1999, “leak detection method for plastic water distribution pipes,” AWWA.

5. Khalifa A., Chatzigeorgiou D., Youcef-Toumi K., Khulief Y., Ben-Mansour R., 2010, “Quantifying Acoustic and Pressure Sensing for In-pipe Leak Detection,” ASME International Mechanical Engineering Congress & Exposition (IMECE), Vancouver, Canada.

What is claimed is:

1. Leak detection system for locating leaks in a pipeline that includes RFID tags deployed at known locations along the pipeline comprising:
a pair of bodies tethered to one another a fixed distance apart, each body supported for movement substantially along the centerline of the pipeline, each body including a sensor responsive to sound or pressure variations generated by a leak and an RFID reader for reading the RFID tags in the pipeline;
at least one of the bodies including a power supply and/or electronics, the electronics adapted to correlate signals from the sensor on each body to determine the location of a leak within the pipeline.

2. The system of claim 1 wherein the electronics includes means for recording signals for post-processing.

3. The system of claim wherein the bodies are supported by wheels engaging the inside of the pipeline.

4. The system of claim 1 wherein the sensors are hydrophones or dynamic pressure transducers.

5. The system of claim 1 wherein the sensors are connected to a platform for power supply and signal conditioning.

6. The system of claim 1 wherein the electronics includes a processor for discretization, filtering and correlating signals from the sensors on each body.

7. The system of claim 1 wherein the bodies travel with the flow in the pipeline.

8. The system of claim 1 wherein at least one of the bodies includes propulsion means for moving the bodies along the pipeline.

9. The system of claim 1 wherein communication of data is either downloaded when the system is collected physically, or sent wirelessly while moving inside the pipeline.
